(19) United States
(12) Patent Application Publication
(10) Pub. No.: US 2019/0023062 A1
(43) Pub. Date: Jan. 24, 2019

(54) LIQUID MANAGEMENT SYSTEM (LMS)

(71) Applicant: James Elree Hamilton, Georgetown, TX (US)

(72) Inventor: James Elree Hamilton, Georgetown, TX (US)

(21) Appl. No.: 16/033,435

(22) Filed: Jul. 12, 2018

Related U.S. Application Data
(60) Provisional application No. 62/604,788, filed on Jul. 21, 2017.

(51) Int. Cl. B44D 3/12

(52) U.S. Cl. CPC B44D 3/12

(57) ABSTRACT

A liquid management system to manage liquid in a can includes a pump coupled to the can, a paint tray coupled to an output of the pump, and an organizer having recesses to receive the can, pump and paint tray.

### BACKGROUND

The present invention relates to the field of liquid management tools and accessories, more specifically, a paint liquid management system.

Many industrial, commercial, and consumer liquids come in 1 gallon, 5 gallon, and 50 gallon containers. Often times only a small amount of these liquids are need at a time during the application or when distributing to a smaller container for handling or application. Example: a 5-gallon paint container is much more economical to purchase, but it is cumbersome to use when pouring into a roller tray for application, often resulting in spills that can be damaging and time consuming to clean up. The larger containers are also much heavier and challenging for many individuals when moving them around during the use or application of the liquid. Many consumers often opt to pay significantly more for individual gallon containers for these very issues. Many liquids are a compound of a variety of materials and/or fluids that separate when left stagnant for a period of time resulting in the need to manually stir, mix or shake the contents of the materials for distribution or application, the larger the containers the more difficult it is to properly mix the separated liquids or materials. As a result, the handling liquids such as paint often results in spillage.

### SUMMARY

A liquid management system to manage liquid in a can includes a pump coupled to the can, a paint tray coupled to an output of the pump, and an organizer having recesses to receive the can, pump and paint tray.

In another aspect, a method to manage liquid from a can includes placing the can, a pump and a paint tray in recesses of an organizer; pumping the liquid from a can to a paint tray; and applying a roller to the paint tray and painting with the roller.

The Liquid Management System (LMS) addresses many of these issues by using a variety of pump systems to easily disperse liquids into alternative containers or locations for use, application, storage or any other need. One embodiment utilizes a manual hand pump for use anywhere. For high volume, the system can use a drill pump that that is powered by an electric drill that attaches to a shaft of the pump. In another embodiment, the system works with an integrated electric pump that utilizes a rechargeable electric motorized pump. The LMS allows for the dispersion of the liquids with the depression of a button, switch, or voice activated system to move the liquid. The system also incorporates a recirculation process that allows for the mixing of the materials or fluids that may have become separated during a period of stagnation. This is accomplished through redirecting the flow of the material or fluid back into the original container creating a recirculation of the material within the original container. The LMS can be integrated with a rolling dolly platform for the easy movement of the containers. The system also greatly reduces the possibility of spillage by moving the liquid through a managed process versus the typical pouring of the liquid from one container to another. In one example, a 5 gallon paint container is much more economical to purchase, but it is cumbersome when pouring into a roller tray for application, often resulting in spills that can be damaging and time consuming to clean up. Using the LMS, the 5 gallon container is secured on the rolling dolly platform and the pump mechanism is attached to the opening in the top of the 5 gallon can. The larger containers are also much heavier and challenging for many individuals when moving them around during the use or application of the liquid. The use of the system helps consumer save money when they can buy a large can (five-gallon container) and dispense easily as though individual, more expensive one-gallon containers are used. The system also provides a plurality of paint tool securing means that are integrated within or atop of the system, which can store paint tools between use. The system also provides a removable paint tray container.

These together with additional objects, features and advantages of the paint carrier and organizer will be readily apparent to those of ordinary skill in the art upon reading the following detailed description of presently preferred, but nonetheless illustrative, embodiments of the paint carrier and organizer when taken in conjunction with the accompanying drawings.

In this respect, before explaining the current embodiments of the paint carrier and organizer in detail, it is to be understood that the paint carrier and organizer is not limited in its applications to the details of construction and arrangements of the components set forth in the following description or illustration. Those skilled in the art will appreciate that the concept of this disclosure may be readily utilized as a basis for the design of other structures, methods, and systems for carrying out the several purposes of the paint carrier and organizer.

It is therefore important that the claims be regarded as including such equivalent construction insofar as they do not depart from the spirit and scope of the paint carrier and organizer. It is also to be understood that the phraseology and terminology employed herein are for purposes of description and should not be regarded as limiting.

The liquid management system allows for the easy handling, moving, distribution, mixing, and transfer of liquids from a container to a preferred location without heavy lifting, pouring, spilling, and cleanup often associated with these tasks. The liquid management system includes a pump and cap assembly for the quick and easy attachment to the original container, a rolling dolly platform consisting of multiple wheels, indentations or mechanical fasteners to hold the containers or receptacles in place while in use. The system is modular to allow for the easy expansion or replacement of components.

There and other objects, advantages, and features of the invention will be set forth in the detailed description which follows.

### BRIEF DESCRIPTION OF THE DRAWING

In the detailed description which follows, reference will be made to the drawing comprised of the following figures:

FIG. 1 is a top view of a liquid management system which is used in the combination of the preferred embodiment;

FIG. 2 is a sideview of the system of FIG. 1;

FIG. 3 is an end view of the system of FIG. 1; and

FIG. 4 is a perspective view of the system of FIG. 1.

FIG. 5A is a side view of a wheeled embodiment.

FIG. 5B shows a side view.

FIG. 5C shows a top view of another embodiment with four legged bracket sets on the unit of FIG. 1.

FIGS. 6A-6E shows exemplary trim bucket views.

FIG. 7 shows an exemplary process to control the system of FIG. 1.

FIG. 8 shows an exemplary computer-controlled pump with voice recognition for dispensing the liquid.

### DETAILED DESCRIPTION OF THE EMBODIMENT

The following detailed description is merely exemplary in nature and is not intended to limit the described embodiments of the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to practice the disclosure and are not intended to limit the scope of the appended claims. Furthermore, there is no intention to be bound by any expressed or implied theory presented in the preceding technical field, background, brief summary or the following detailed description.

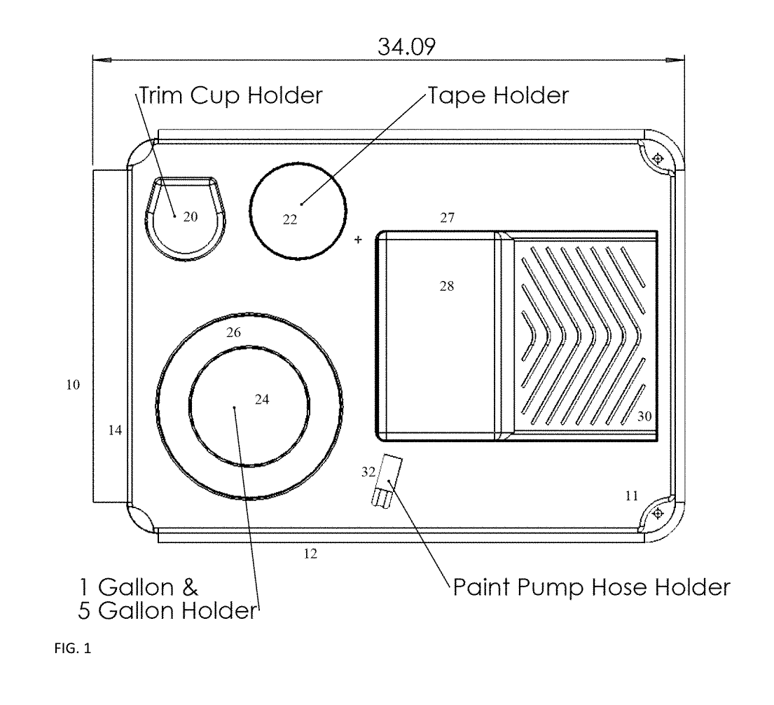

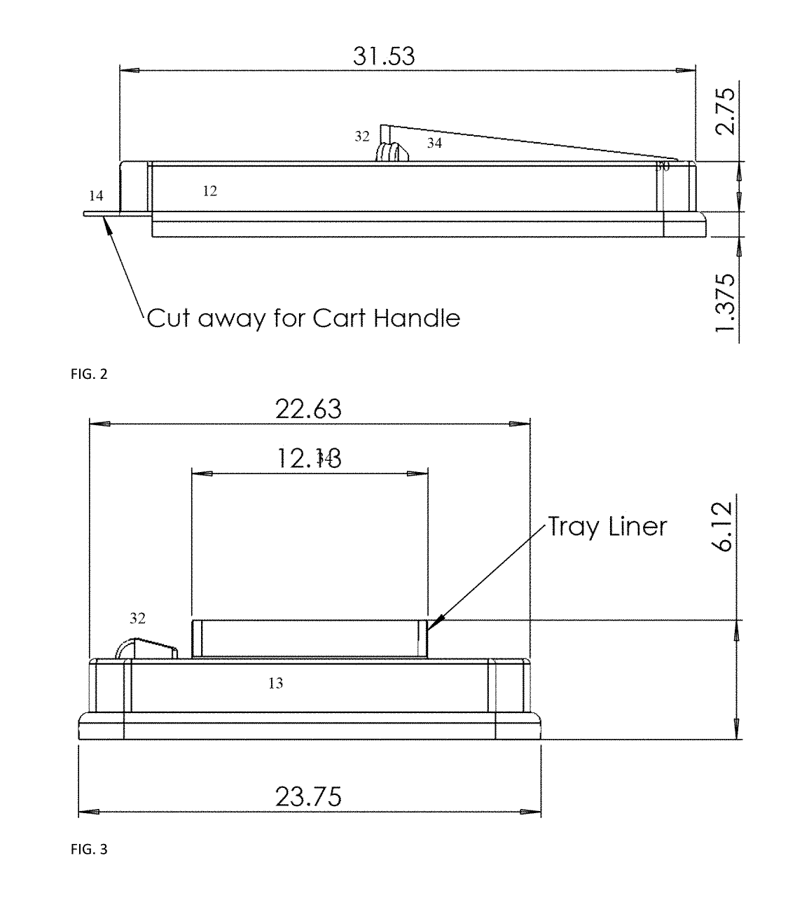

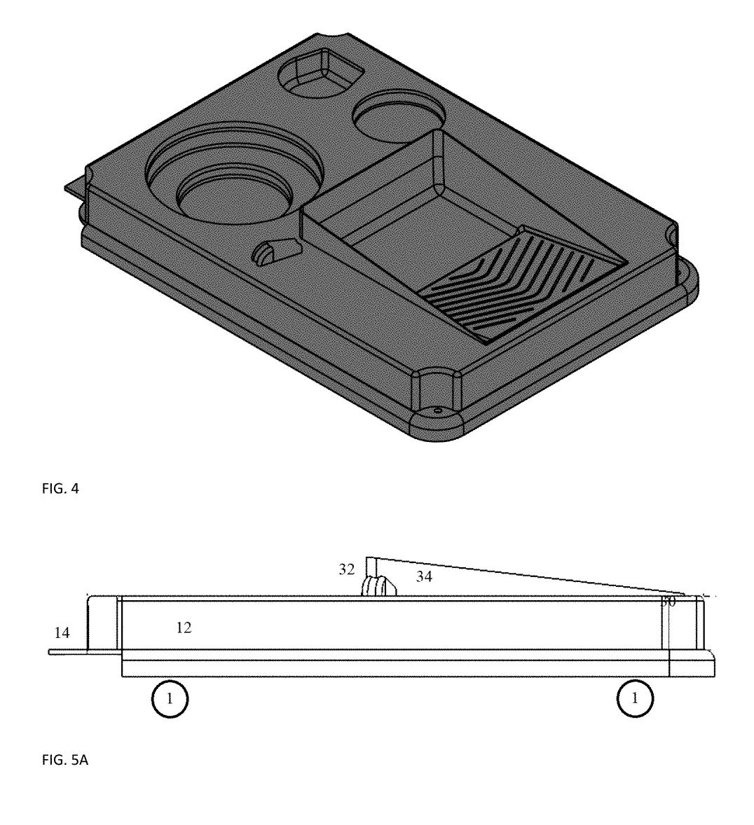

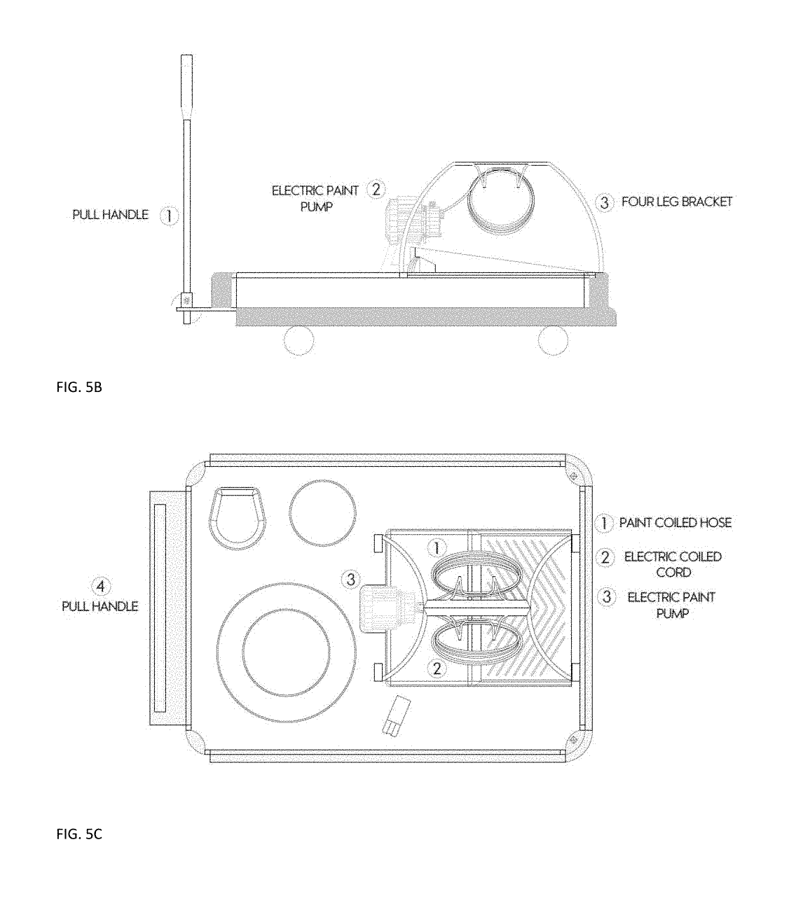

Detailed reference will now be made to the preferred embodiment of the present invention, examples of which are illustrated in FIGS. 1-4. A Liquid Management System (LMS) is shown in FIG. 1. FIG. 2 is a sideview of the system of FIG. 1; while FIG. 3 is an end view of the system of FIG. 1; and FIG. 4 is a perspective view of the system of FIG. 1. The LMS includes a liquid container removably coupled to a pump and a liquid dispensing tray to receive liquid dispensed by the pump, wherein the tray has a deep region as a liquid receptacle and a shallow or beach region to dispense the liquid to a roller. In one embodiment, the beach area has protrusions with flow channels to catch excessive liquid from the roller after the roller has been dipped into the deep side of the tray to avoid excess drippings from the roller.

The LMS works with a variety of pump systems to easily disperse liquids into alternative containers or locations for use, application, storage or any other need. One embodiment utilizes a manual hand pump for use anywhere. The hand pump can be used to mix paint from the paint trays and then dispense the paint to the paint tray, for example. For high volume, the system works with a drill pump that that is powered by an electric drill that attaches to a shaft of the pump. In another embodiment, the system works with an integrated electric pump that utilizes a rechargeable electric motorized pump. The LMS allows for the dispersion of the liquids with the depression of a button, switch, or voice activated system to move the liquid. The system also incorporates a recirculation process that allows for the mixing of the materials or fluids that may have become separated during a period of stagnation. This is accomplished through redirecting the flow of the material or fluid back into the original container creating a recirculation of the material within the original container. The LMS can be integrated with a rolling dolly platform for the easy movement of the containers. The system also greatly reduces the possibility of spillage by moving the liquid through a managed process versus the typical pouring of the liquid from one container to another. In one example, a 5 gallon paint container is much more economical to purchase, but it is cumbersome when pouring into a roller tray for application, often resulting in spills that can be damaging and time consuming to clean up. Using the LMS, the 5 gallon container is secured on the rolling dolly platform and the pump mechanism is attached to the opening in the top of the 5 gallon can. The larger containers are also much heavier and challenging for many individuals when moving them around during the use or application of the liquid. The use of the system helps consumer save money when they can buy a large can (five-gallon container) and dispense easily as though individual, more expensive one-gallon containers are used.

Turning now to FIG. 1, one embodiment of the LMS 10 (hereinafter the preferred embodiment) includes a body with walls 12-13. A tab or cart handle 14 extends from one end of the organizer 10. The walls have inwardly curved edges 11 with recesses therein to allow stacking of the organizer 10 for transportation purposes, among others. On top of the organizer 10, a plurality of recessed structures are formed to secure various paint accessories. For example, a substantially horseshoe shaped or U-shaped recess 20 is provided as a trim cup holder. A recessed circular tape holder 22 is provided to hold painting tapes. A paint container 27 is provided to hold a roller pan. In one embodiment, the paint tray is a substantially rectangular open-ended structure that receives a replaceable roller pan. The roller pan in turn has an angled paint reservoir or well 28 and a paint roller area or beach area 30. The reservoir or well 28 is deeply angled at one end to store paint, and the beach area 30 is less steep with a plurality of V shaped protrusions to remove and drain excess paint away from the roller back to the reservoir or well 28.

When painting a room with a paint roller it is normally necessary to continually refill the paint tray. When pouring from a paint 5-gallon bucket, there is always paint that spills on the outside of the can/bucket and onto the floor or mat under it This causes a mess and wasted paint The pump siphons the paint from the 5-gallon bucket via a hose in the bucket and transfers it from the bucket to the pump and on to the paint tray without ever having to lift the paint bucket and pour the paint, Therefore eliminating the mess associated with pouring paint into the paint tray and saving a great deal of time to paint. The paint platform includes a small paint trim bucket which is used to paint those area that the paint roller cannot easily reached such as around windows and baseboards, without applying paint to areas that you do not want. The paint trim bucket can be easily filled from the 5-gallon bucket delivery system and placed on the paint platform in the paint trim bucket holder area.

A substantially multi-level cylindrical paint holder is provided. The holder has a first circular region 24 with a smaller diameter to hold one-gallon paint container, while a second circular region 26 is positioned above the first circular region 24 to accept a five-gallon paint container. The pump (not shown) is provided to transfer paint from the paint container to the roller pan. The pump can be a syringe type manual pump or can be a motorized pump.

The liquid management system allows for the easy handling, moving, distribution, mixing, and transfer of liquids from a container to a preferred location without heavy lifting, pouring, spilling, and cleanup often associated with these tasks. The liquid management system includes a pump and cap assembly for the quick and easy attachment to the original container, a rolling dolly platform consisting of multiple wheels, indentations or mechanical fasteners to hold the containers or receptacles in place while in use. The system is modular to allow for the easy expansion or replacement of components.

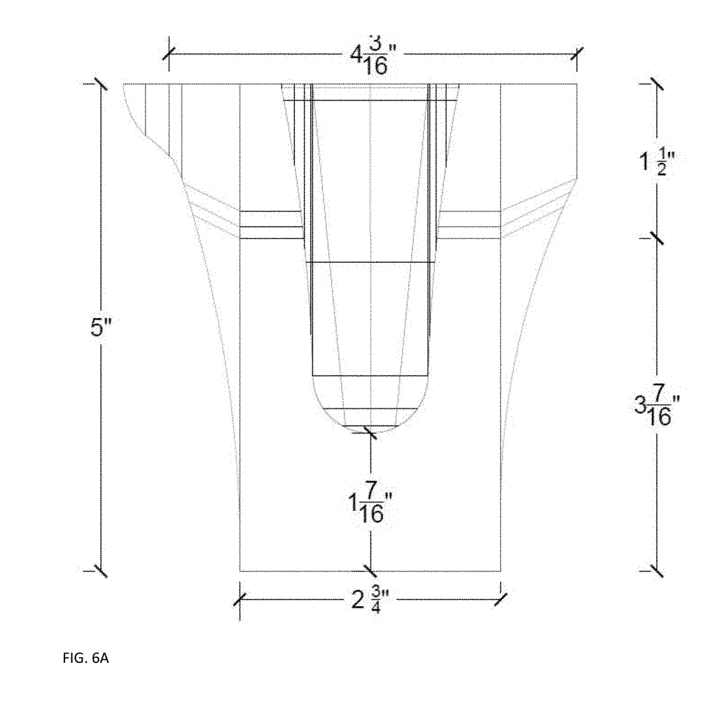

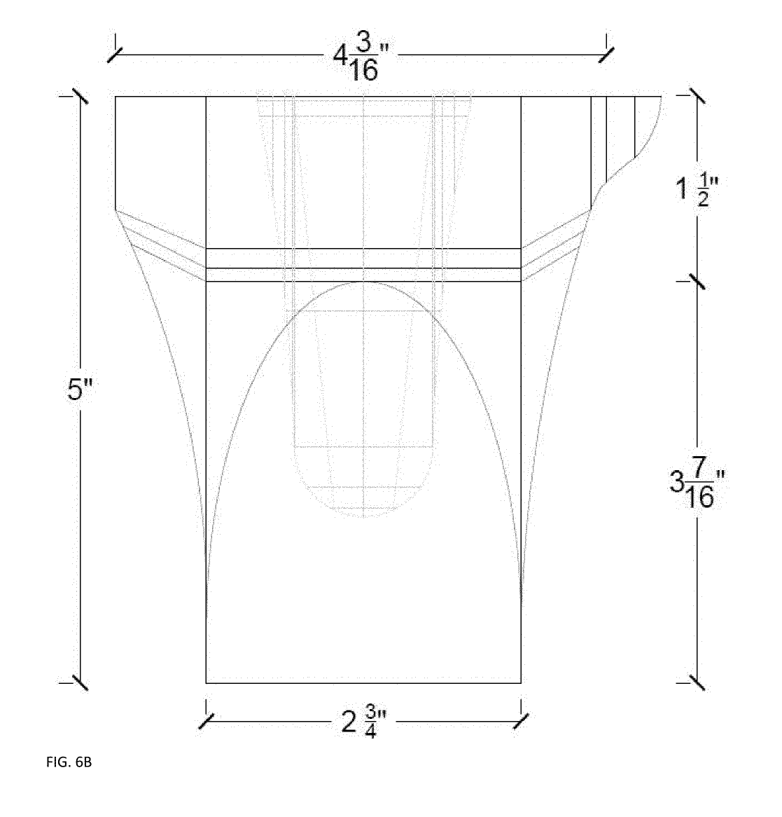

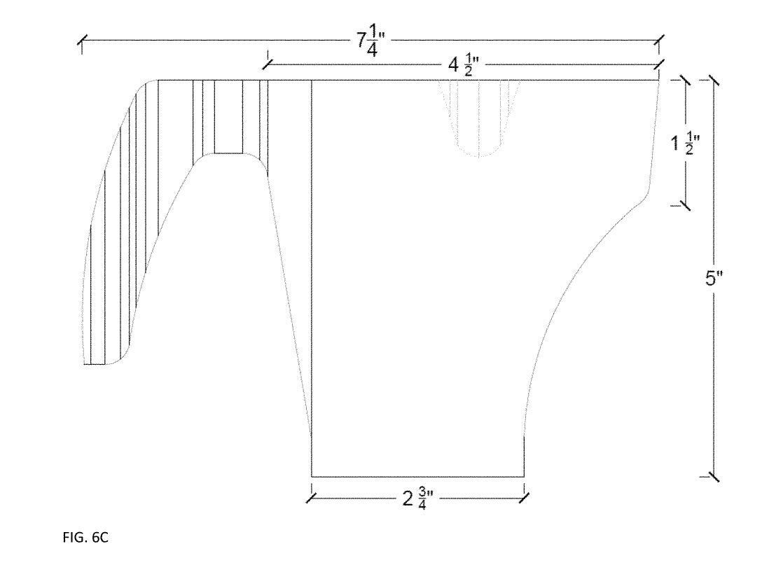

FIG. 5A is a side view of a wheeled embodiment or a rolling dolly platform. In this embodiment, wheels 1 are positioned under the paint can and paint tray carrier so that the unit can be easily moved as the painting progresses. Moreover, the platform can be raised or retracted from the raised position so that the painter or user can have easy access to the pain tray.

FIG. 5B shows a side view while FIG. 5C shows a top view of another embodiment of FIG. 5A. In this embodiment, four legged bracket sets are used in the paint tray to hold the paint pump hose on one side of the bracket, and electric cable is positioned on the other side of the bracket. An electric paint pump is positioned near the legged bracket sets, and a bracket or hook is positioned at the middle of the four legged bracket sets to hold the hose and the electric cable. The unit is moveable by wheels at the bottom, which can be interchangeable to adjust for ground conditions or ground clearance as needed. A pull handle can be provided for ease of moving the unit by hand.

An exemplary hand-pump can be used. This embodiment is a syringe ideal for the transfer of fluids such as paint to and from the paint can and paint tray, for example. A translucent body allows easy inspection of paint dispensing. While a hand-pump is shown is described, an electric pump can be used as well.

Alternatively an airless paint sprayer such as the Magnum ProX19 which has fully adjustable pressure to provide control of paint flow for any project size. Other features include

Flexible suction tube allows user to spray directly from a 1 or 5 gal. paint bucket

Can support up to 150 ft. of paint hose giving you extra reach for user jobs

Annual use recommendation is up to 500 gal. per year

Supports up to a maximum tip size of 0.019 in.

RAC IV SwitchTip allows user to reverse the tip when clogged to keep spraying

SG3 metal spray gun with built in swivel and in-handle filter blocks debris to prevent tip clogs

Prime button for fast and reliable start-up

ProX stainless steel piston pump allows y user ou to spray paint unthinned at high pressure

PowerFlush adapter connects to a garden hose for fast and easy cleaning

Convenient aluminum cart allows for easy movement of sprayer and paint around job site

The unit includes SG3 metal spray gun with build in swivel, RAC IV 515 switch tip, 50 ft. Duraflex paint hose, pump armor storage fluid, Flush adapter.

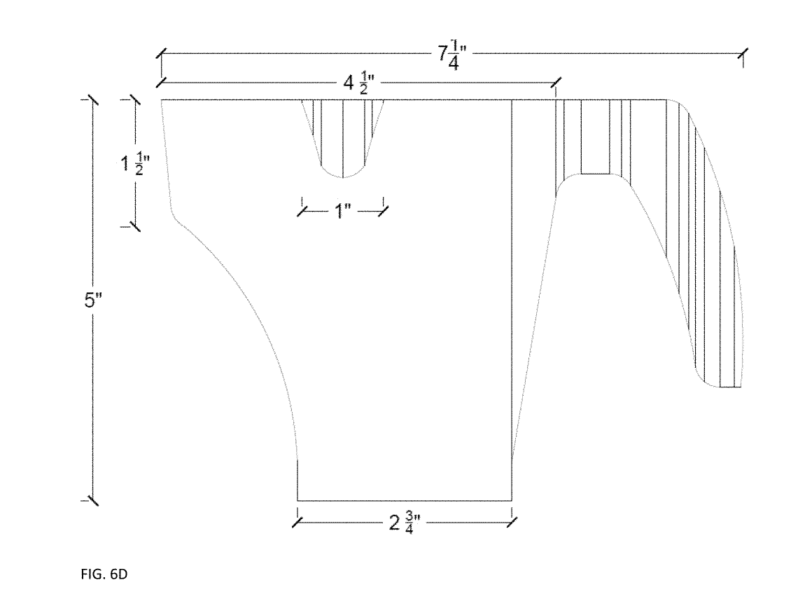

FIGS. 6A-6E shows exemplary trim bucket views. The bucket has a bottom to be seated on the platform of FIG. 5A. In one embodiment, the lid of the bucket is circular and the ceiling of the bucket gradually tapers and reduces to a circular bottom with a small diameter that fits with the corresponding opening on the platform of FIG. 5A. While the shapes are circular, they can be any other suitable shape such as square shapes or rectangular shapes, for example.

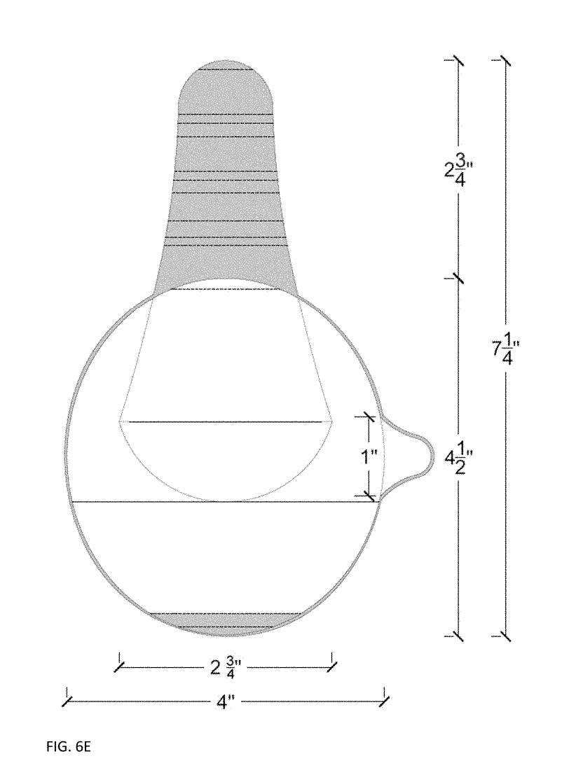

FIG. 7 shows an exemplary process for managing liquid dispensing. In this process, the system operates as follows:
Place paint can into the holder region (200)
Place paint tray into the paint holding area (202)
Optionally place tape and trim materials into their respective cup holder (204)
Clip pump hose to the holder (206)
Place pump to contact paint (208)
Direct paint to flow from pump to the paint tray (210)

Working with a paint roller is easier than working with a brush. One process is as follows: moisten the roller first with water for latex paint or the appropriate thinner for other types of paint. Roll out the excess moisture on a piece of scrap lumber or kraft paper or even on a paper grocery bag. Fill the well of the roller pan about half full and set the roller into the middle of the well. Lift the roller and roll it down the slope of the pan, stopping just short of the well. The paint rolling action is repeated two or three times to allow the paint to work into the roller. Then, dip the roller into the well once more, and roll it on the slope until the pile is well saturated. When the roller is overloaded, the roller will drip enroute to the wall and have a tendency to slide and smear instead of roll across the surface.

An effective method of painting with a roller is to paint 2- or 3-square-foot areas at a time. Roll the paint on in a zigzag pattern without lifting the roller from the wall, as if painting a large M, W, or backward N. Then, still without lifting the roller, fill in the blanks of the letters with more horizontal or vertical zigzag strokes. Finish the area with light strokes that start in the unpainted area and roll into the paint. At the end of the stroke, raise the roller slowly so it does not leave a mark. Go to the next unpainted area, and repeat the zigzag technique, ending it just below or next to the first painted patch. Finally, smooth the new application, and blend it into the previously finished area.

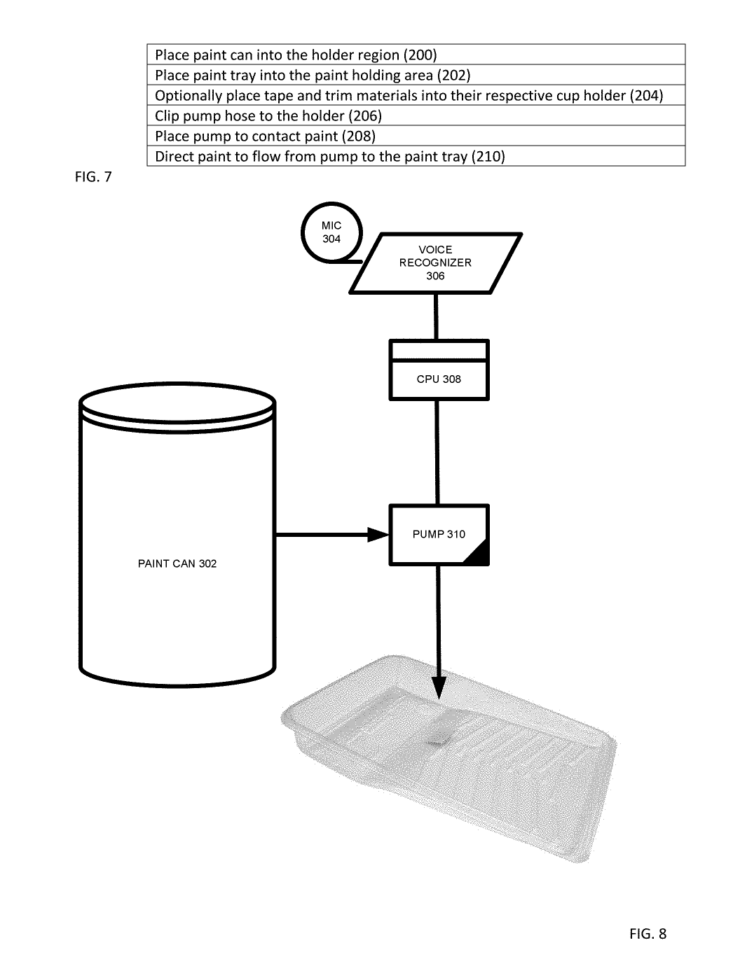

FIG. 8 shows an exemplary computer-controlled pump with voice recognition for dispensing the liquid such as paint from a paint can 302. In this system, voice is captured by a microphone 304 which is provided to a voice recognizer 306. A processor 308 receives the output from the voice recognizer and detects a voice command such as “turn pump on” and directs the pump 310 to move a viscous liquid such as paint to the paint tray. In one embodiment, the voice recognizer can be Siri from Apple, Google Voice from Google, or Amazon voice recognizer Alexa, among others. The embodiment of FIG. 7 allows voice activation of the pump so that the user can paint without having to stop, push a button, and go back to painting.

The liquid management system allows for the easy handling, moving, distribution, mixing, and transfer of liquids from a container to a preferred location without heavy lifting, pouring, spilling, and cleanup often associated with these tasks. The liquid management system includes a pump and cap assembly for the quick and easy attachment to the original container, a rolling dolly platform consisting of multiple wheels, indentations or mechanical fasteners to hold the containers or receptacles in place while in use. The system is modular to allow for the easy expansion or replacement of components.

With respect to the above description, it is to be realized that the optimum dimensional relationship for the various components of the invention 100, to include variations in size, materials, shape, form, function, and the manner of operation, assembly and use, are deemed readily apparent and obvious to one skilled in the art, and all equivalent relationships to those illustrated in the drawings and described in the specification are intended to be encompassed by the invention 100.

With respect to the above description, it is to be realized that the optimum dimensional relationship for the various components of the preferred embodiment 10, to include variations in size, materials, shape, form, function, and the manner of operation, assembly and use, are deemed readily apparent and obvious to one skilled in the art, and all equivalent relationships to those illustrated in the drawings and described in the specification are intended to be encompassed by the system 10.

It is possible to vary the design and position of the pockets described and depicted. It is also possible to eliminate certain parts of the construction, such as the handle or the apron which fits into the bucket. It is also possible to extend the apron for the full length of the interior of the bucket. Various other combinations and permutations are possible within the spirit and scope of the invention. The invention is therefore limited only by the following claims and equivalents thereof.

It shall be noted that those skilled in the art will readily recognize numerous adaptations and modifications which can be made to the various embodiments of the present invention which will result in an improved invention, yet all of which will fall within the spirit and scope of the present invention as defined in the following claims. Accordingly, the invention is to be limited only by the scope of the following claims and their equivalents.

What is claimed is:

1. A liquid management system to manage liquid in a can, comprising:
a pump coupled to the can;
a paint tray coupled to an output of the pump, and
an organizer having recesses to receive the can, pump and paint tray.

2. The system of claim 1, comprising a processor coupled to the pump.

3. The system of claim 1, comprising a voice recognizer coupled to the pump, the voice recognizer operating the pump based on voice command.

4. The system of claim 1, wherein the organizer comprises circular recesses to secure the can to a surface of the organizer and a rectangular open-ended box on the surface to receive the paint tray.

5. The system of claim 4, comprising a holder for a trim cup and a holder for a tape on the surface.

6. The system of claim 4, wherein the circular recesses comprise a first level to hold a one-gallon can and a second level to hold a five gallon can.

7. The system of claim 1, comprising a rolling dolly platform to move the organizer.

8. The system of claim 1, wherein the pump comprises one of: a hand pump, a drill pump, a motorized pump.

9. The system of claim 1, wherein the pump recirculates the liquid during a period of stagnation.

10. The system of claim 1, wherein the liquid comprises a viscous liquid.

11. A method to manage liquid from a can, comprising:
placing the can, a pump and a paint tray in recesses of an organizer;
pumping the liquid from a can to a paint tray; and
applying a roller to the paint tray and painting with the roller.

12. The method of claim 11, comprising controlling the pump with a processor.

13. The method of claim 1, comprising recognizing voice and operating the pump based on voice command.

14. The method of claim 1, wherein the organizer comprises circular recesses to secure the can to a surface of the organizer and a rectangular open-ended box on the surface to receive the paint tray.

15. The method of claim 14, comprising providing a holder for a trim cup and a holder for a tape on the surface.

16. The method of claim 14, wherein the circular recesses comprise a first level to hold a one-gallon can and a second level to hold a five gallon can.

17. The method of claim 11, moving the organizer with rolling dolly platform.

18. The method of claim 11, wherein the pump comprises one of: a hand pump, a drill pump, a motorized pump.

19. The method of claim 11, wherein the pump recirculates the liquid during a period of stagnation.

20. The method of claim 11, wherein the liquid comprises a viscous liquid.
